(19) United States
(12) Patent Application Publication
(10) Pub. No.: US 2008/0045616 A1
(43) Pub. Date: Feb. 21, 2008

(54) METHOD FOR FABRICATING A COMPOSITE SOLID POLYMER ELECTROLYTE MEMBRANE

(76) Inventors: Gwo-Mei WU, Taishan Shiang (TW); Sheng-Jen Lin, Taipei City (TW); Chun-Chen Yang, Tao-Yuan (TW); Jiun-Ming Chiu, Tao-Yuan (TW)

Correspondence Address: SINORICA, LLC, 528 FALLSGROVE DRIVE, ROCKVILLE, MD, 20850, US

(21) Appl. No.: 11/623,769

(22) Filed: Jan. 17, 2007

(30) Foreign Application Priority Data
Aug. 15, 2006 (TW) 95129876

(51) Int. Cl. C08J 5/22

(52) U.S. Cl. 521/27; 521/30

(57) ABSTRACT

The present invention discloses a method for fabricating a composite solid polymer electrolyte membrane, wherein a flushed and dried membrane is sulfonated with sulfuric acid; the sulfonated membrane is flushed and dried once more; a first polymer solution is mixed with a second polymer solution, which has been hydrolyzed and neutralized, to form a blended polymer solution; the sulfonated membrane is immersed into the blended polymer solution; a cross-linking agent and an initiator are sequentially added into the blended polymer solution to implement a polymerization reaction; after the polymerization reaction, the blended polymer solution-containing sulfonated membrane is placed on a plate and dried; after the drying, a composite solid polymer electrolyte membrane is thus completed. Thereby, the present invention can fabricate a high ionic conductivity and high mechanical strength composite solid polymer electrolyte membrane.

### BACKGROUND OF THE INVENTION

1. Field of the Invention

The present invention relates to a method for fabricating a polymer electrolyte membrane, particularly to a method for fabricating a composite solid polymer electrolyte membrane.

2. Description of the Related Art

In a traditional battery, the separating membrane is soaked in liquid electrolyte and provides the transferring space for ions, and the separating membrane also separates the positive and negative electrodes to prevent the positive and negative electrodes from contact and short circuit. The PP/PE (polypropylene/polyethylene) non-woven cloth is the most common material for separating membranes. However, the PP/PE non-woven cloth itself does not possess ionic conductivity but has a low absorptivity of electrolyte solution. Besides, the PP/PE non-woven cloth occupies a considerable space in the interior of a battery. Thus, the room accommodating the active materials of the positive and negative electrodes is reduced, and the performance of the battery is hard to promote. Under such a condition, the capacity of a battery can only be raised via increasing its size. However, such a method makes the battery become bulkier and heavier. Under the current trend that electronic products tend to be slim and lightweight, such a kind of battery will lose its competitiveness.

A polymer battery has been developed to solve the abovementioned problems, wherein an SPE (Solid Polymer Electrolyte) membrane is used as the separating membrane of the positive and negative electrodes and functions as a solid polymer electrolyte. Such a polymer battery does not contain any free liquid, and the electrolyte is contained in a gel-like solid. The solid polymer electrolyte will not deteriorate easily but can maintain stable for a long time during repeated charge/discharge operations; therefore, the performance of batteries can be promoted. The polymer electrolyte has a high ionic conductivity and a high absorptivity of electrolyte solution; thus, the SPE membrane occupies less space. Besides, the SPE membrane can absorb redundant solution; thus, the problem of electrolyte leakage is solved. When the SPE membrane is used in a very slim battery, none electrolyte leakage will occur. As none free liquid exists in the SPE membrane, the assemblage of batteries is easier, and the safety of batteries is also greatly promoted. However, the expansion pressure occurring in the charge and discharge process of a battery usually exceeds the mechanical strength of the polymer membrane. Thus, the polymer membrane is usually locally damaged, and the short circuit and breakdown of the battery occurs. Therefore, improving the mechanical strength of the solid polymer electrolyte membrane, which has possessed a high ionic conductivity, is the problem the manufacturers desire to solve.

Accordingly, the present invention proposes a method for fabricating a composite solid polymer electrolyte membrane to overcome the abovementioned problems.

### SUMMARY OF THE INVENTION

The primary objective of the present invention is to provide a method for fabricating a composite solid polymer electrolyte membrane, whereby a high ionic conductivity and high mechanical strength composite solid polymer electrolyte membrane can be fabricated.

Another objective of the present invention is to provide a method for fabricating a composite solid polymer electrolyte membrane, which has the advantages of low cost and high base resistance.

Further objective of the present invention is to provide a method for fabricating a composite solid polymer electrolyte membrane, which can improve the problem of electrolyte leakage in batteries.

According to one aspect, the method for fabricating a composite solid polymer electrolyte membrane of the present invention comprises the following steps: firstly, after flushing and drying, a membrane is sulfonated with sulfuric acid to form a sulfonated membrane; next, the sulfonated membrane is flushed and dried once more; next, a first polymer solution and a second polymer solution are provided, and a basic solution is added into the second polymer solution to implement a hydrolysis and neutralization reaction, and the hydrolyzed and neutralized second polymer solution is mixed with the first polymer solution to obtain a blended polymer solution; next, the sulfonated membrane is immersed into the blended polymer solution, and a cross-linking agent and an initiator are sequentially added into the blended polymer solution to implement a polymerization reaction; and after the polymerization reaction, the blended polymer solution-containing sulfonated membrane is placed on a plate and dried. Then, a composite solid polymer electrolyte membrane is completed after drying. The abovementioned membrane may be a polyethylene/polypropylene non-woven cloth, a polypropylene cloth, or a polyethylene cloth. The first polymer solution is obtained via mixing 1-90 wt. % of PVA (polyvinyl alcohol) or PEO (polyethylene oxide) with 50-80 wt. % of water at a temperature of 50-90□ inside an airtight environment. The second polymer solution comprises 1-90 wt. % of PAA (polyacrylic acid) monomer of more than 90% purity. The composite solid polymer electrolyte membrane of the present invention can be applied to various electrochemical systems.

To enable the objectives, technical contents, characteristics and accomplishments of the present invention to be easily understood, the embodiments of the present invention is to be described in detail in cooperation with the attached drawings.

### BRIEF DESCRIPTION OF THE DRAWINGS

FIG. 1 is a flowchart of the method according to the present invention;

FIG. 2 is a diagram schematically showing the reaction between the sulfonated polyethylene/polypropylene non-woven cloth and the blended polymer solution of polyvinyl alcohol and polyacrylic acid;

FIG. 3 is the 1000× topography of the composite solid polymer electrolyte membrane fabricated via sulfonating the polyethylene/polypropylene non-woven cloth for 3 hours and soaking the sulfonated polyethylene/polypropylene non-woven cloth in the blended polymer solution with the blending ratio of PVA to PAA 10:5;

FIG. 4 is the 1000× topography of the composite solid polymer electrolyte membrane fabricated via sulfonating the polyethylene/polypropylene non-woven cloth for 72 hours and soaking the sulfonated polyethylene/polypropylene non-woven cloth in the blended polymer solution with the blending ratio of PVA to PAA 10:5;

FIG. 5 is a diagram showing the results of the X-ray diffractometry for the samples fabricated according to the method of the present invention;

FIG. 6 is a diagram showing the results of the test performed with the differential scanning calorimeter for the samples fabricated according to the method of the present invention;

FIG. 7 is a Nyquist diagram for the samples fabricated according to the method of the present invention;

FIG. 8 is a diagram schematically showing the structure of a Zn-air fuel battery adopting the composite solid polymer electrolyte membrane fabricated according to the method of the present invention;

FIG. 9 is a diagram showing the relationships between the time and the electromotive forces of the Zn-air batteries adopting the composite solid polymer electrolyte membrane fabricated according to the method of the present invention and discharging at the rate of C/10; and

FIG. 10 is a diagram showing the curves of the discharge powers of the Zn-air batteries adopting the composite solid polymer electrolyte membrane fabricated according to the method of the present invention.

### DETAILED DESCRIPTION OF THE INVENTION

In the present invention, a membrane is sulfonated to improve the hydrophilicity thereof; a first polymer solution is mixed with a second polymer solution to form a blended polymer solution; the sulfonated membrane is immersed into the blended polymer solution; and a polymerization reaction is undertaken to achieve a high ionic conductivity and high mechanical strength composite solid polymer electrolyte membrane.

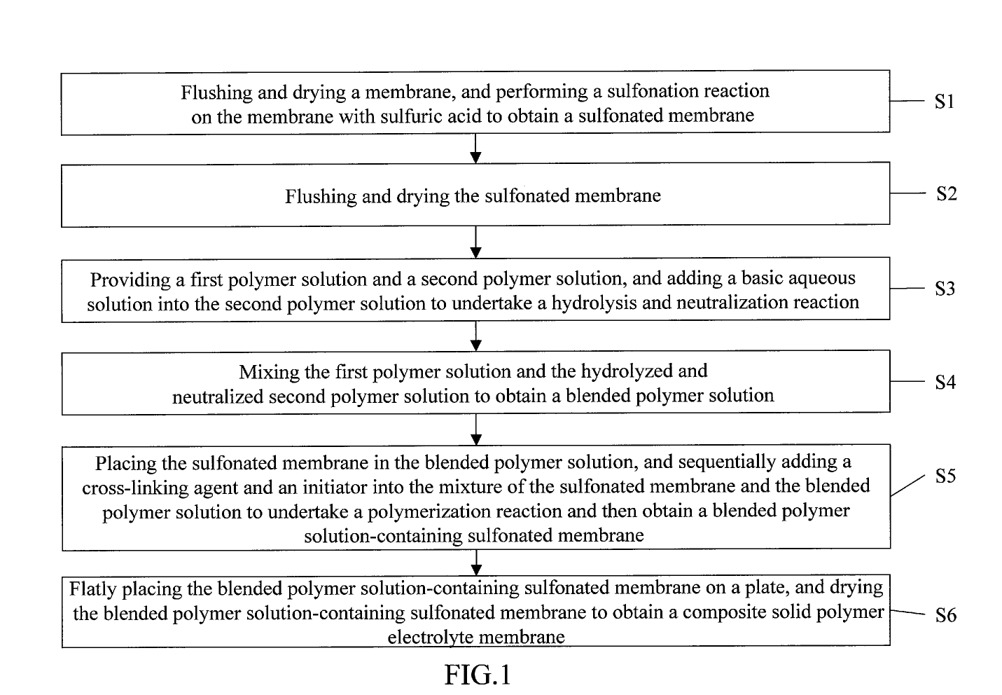

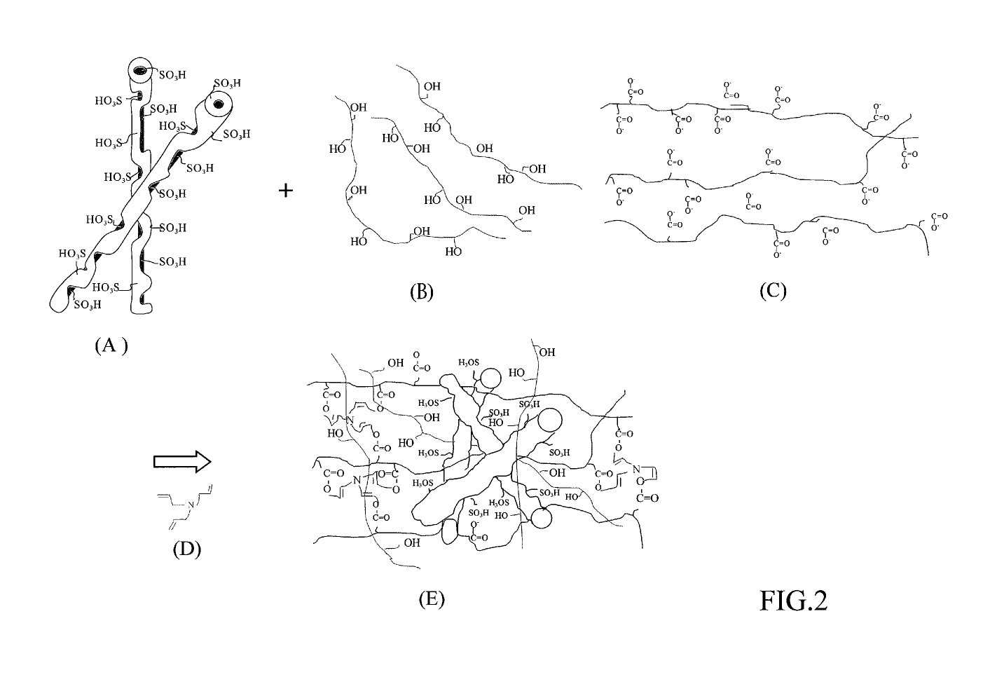

Refer to FIG. 1 a flowchart of the method according to the present invention. In Step S1, a membrane is immersed in ultra-pure water and flushed with an ultrasonic vibrator to remove the impurities on the surface thereof, and then, the cleaned membrane is dried at a baking oven; the membrane may be a polyethylene/polypropylene non-woven cloth with a thickness of 0.05-0.5 mm and a porosity of 20-80%, a polypropylene cloth with a thickness of 0.02-0.5 mm and a porosity of 20-70%, or a polyethylene cloth with a thickness of 0.05-0.5 mm and a porosity of 20-80%; in an airtight environment, the flushed and dried membrane is soaked in a 0.5-18 N (normality) sulfuric acid for sulfonation, and the soaking time varies from 1 to 200 hours according to the required extent of sulfonation; thereby, the sulfonation can proceeds from the surface into the interior, and the membranes with different extends of sulfonation are obtained. In Step S2, the sulfonated membrane is immersed in ultra-pure water and flushed with an ultrasonic vibrator until the pH value of the water running away from the sulfonated membrane is within 6-7; then, the flushed sulfonated membrane is placed inside a cycling baking oven at a constant temperature of 60 □ for 72 hours. In Step S3, a first polymer solution and a second solution are prepared, and a basic aqueous solution is added to the second polymer solution to undertake a hydrolysis and neutralization reaction; 1-90 wt. % of a first polymer is mixed with 50-80 wt. % of water at a temperature of 50-90□ inside an airtight environment, and the mixture is agitated fully to obtain the first polymer solution; the first polymer may be PVA (polyvinyl alcohol) or PEO (polyethylene oxide), and either of them has a purity of 50-99% and a molecular weight of 20000-200000; the second polymer solution comprises 1-90 wt. % of PAA (polyacrylic acid) monomer having a purity of more than 90% and a molecular weight of 72.06; the PAA (polyacrylic acid) monomer may be methylacrylic acid, maleic acid or vinyl acetate; a basic aqueous solution of 50-90% purity, such as the aqueous solution of KOH or NaOH, is added to the second polymer solution to implement a hydrolysis and neutralization reaction, and the neutralization of the second polymer solution is controlled to be within 5-100% and is preferred to be 75%, wherein the basic aqueous solution having the weight equal to that of 1-90% wt. % of PAA (polyacrylic acid) monomer is used in the reaction. In Step S4, the first polymer solution and the hydrolyzed and neutralized second polymer solution are fully mixed to form a blended polymer solution. In Step S5, the sulfonated membrane obtained in Step S2 is placed in the blended polymer solution, and the mixture is agitated fully; a liquid cross-linking agent and an initiator are sequentially added into the mixture to implement a polymerization reaction of free radicals; after the polymerization, a blended polymer solution-containing sulfonated membrane is obtained. For example, as shown in FIG. 2, the sulfonated polyethylene/polypropylene non-woven cloth (A) is placed in the blended polymer solution of PVA (polyvinyl alcohol) (B) and PAA (polyacrylic acid) (C), and TAA (triallyl amine) (D) is used as the cross-linking agent to implement the polymerization reaction, and a blended polymer solution-containing sulfonated polyethylene/polypropylene non-woven cloth (E) is thus obtained. In Step S6, the blended polymer solution-containing sulfonated membrane obtained in Step S5 is flatly placed on a PTFE (polytetrafluoroethylene) plate, and the wet membrane together with the PTFE plate is placed inside a thermohydrostat with a temperature of 40-80□ and a relative humidity of 30-50 RH % for 60-120 minutes, wherein the temperature is preferred to be 50-60□, and the relative humidity is preferred to be below 20-30 RH %; after the drying process is over, the composite solid polymer electrolyte membrane is placed in the air for 30 minutes, and then, it can be easily striped off.

The abovementioned polyethylene/polypropylene non-woven cloth has a shell-core structure, wherein the polypropylene fibers are covered by polyethylene, and polyethylene is heated and fused to form the non-woven cloth. The material of the polyethylene/polypropylene non-woven cloth may be selected from the group consisting of Nylon 6 fiber, Nylon6,6 fiber, polyester fiber and polyester/nylon composite fiber. The cross-linking agent may be beforehand added into the hydrolyzed and neutralized second polymer solution in Step S3, and the cross-linking agent may be selected from the group consisting of TAA (triallyl amine), N,N-dimethyl acrylamide, epichlorohydrin, paraformaldehyde, and polyol (such as ethylene glycol, butylene glycol, and glycerin), and each of those cross-linking agents has a purity of 90-99.99%, and the cross-linking agent having the weight equal to that of 0.001-20 wt. % of PAA (polyacrylic acid) monomer is used in the reaction. The initiator having the weight equal to that of 0.001-20 wt. % of PAA (polyacrylic acid) monomer is used in the reaction, and the initiator may be selected from the group consisting of KPS (potassium persulfate), sodium persulfate, other persulfates and hydrogen peroxide, and each of them has a purity of 80-99%. The initiator may also be APS (ammonium persulfate) with a purity of 90-99%. Besides, ultraviolet light may also be used to illuminate the initiator to induce the polymerization reaction of the monomer.

The composite solid polymer electrolyte membrane fabricated according to the present invention can absorb various solutions, including: basic aqueous solutions, such as the aqueous solutions of NaOH and KOH, acid aqueous solutions, such as the aqueous solutions of sulfuric acid, hydrochloric acid and nitric acid, neutral aqueous solutions, such as the solutions of sodium chloride, potassium chloride, sodium sulfate and potassium sulfate, alcohol solutions, such as the solutions of methyl alcohol, ethyl alcohol, propyl alcohol, isopropyl alcohol and other alcohols, and the solutions of other organic compounds. The composite solid polymer electrolyte membrane fabricated according to the present invention can be applied to various electrochemical systems, including: alkaline electrolysis systems, electroplating systems, Zn-air batteries, Ni—H batteries, Ni—Cd batteries, Ni—Zn batteries, Ag—Zn batteries, direct methyl alcohol fuel batteries, fuel batteries, metal-air batteries, primary alkaline (Zn/MnO₂) batteries, secondary alkaline (Zn/MnO₂) batteries, and electrochemical capacitors. Nanometric granules, submicron granules, or micron granules may be added into the composite solid polymer electrolyte membrane fabricated according to the present invention to improve the ionic conductivity, electrochemical reliability and mechanical strength thereof, and those granules may be selected from the group consisting of hydrophilic granules of silicon dioxide, titanium dioxide, zirconium dioxide and ceramic oxides.

The composite solid polymer electrolyte membrane, which is fabricated according to the steps shown in FIG. 1 and the following conditions, will be tested.
1. The polyethylene/polypropylene non-woven cloth having a thickness of 0.2 mm and a porosity of 70% is sulfated at an airtight environment for 3 hours and 72 hours.
2. The first polymer adopts the PVA (polyvinyl alcohol) with a molecular weight of 75000-80000, and 10 gm of the PVA is added into water, and the solution is agitated at high temperature.
3. 3 gm, 5 gm and 7.5 gm of PAA (polyacrylic acid) monomer each with a purity of more than 95% are respectively used to form the second polymer solutions, and the neutralization extents of the solutions are controlled to be about 75% via adding KOH.
4. 0.5 wt. % of TAA (triallyl amine) is used as the cross-linking agent.
5. 10 wt. % of APS (ammonium persulfate) is used as the initiator, and the polymerization reaction of acrylic radicals is undertaken at a temperature of 80 μl.
6. The wet composite solid polymer electrolyte membrane is dried in a thermohydrostat with a temperature of 55□ and a relative humidity of 10% RH.

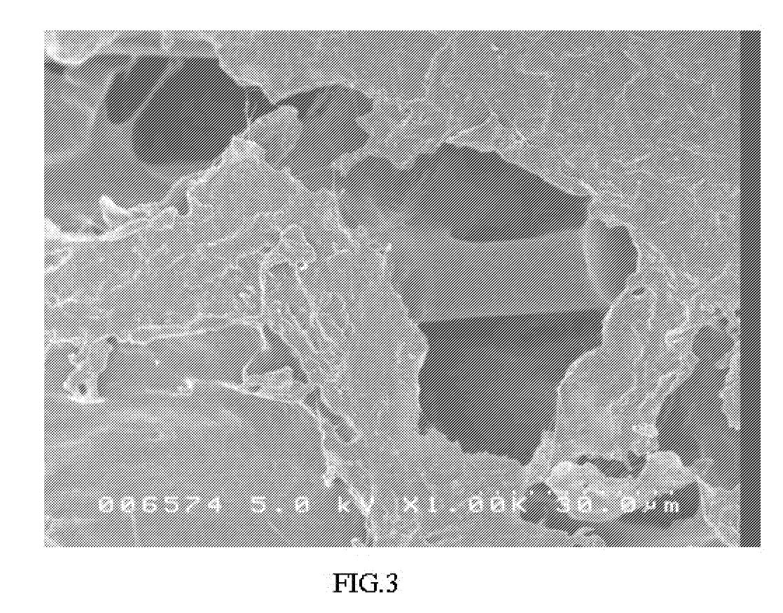

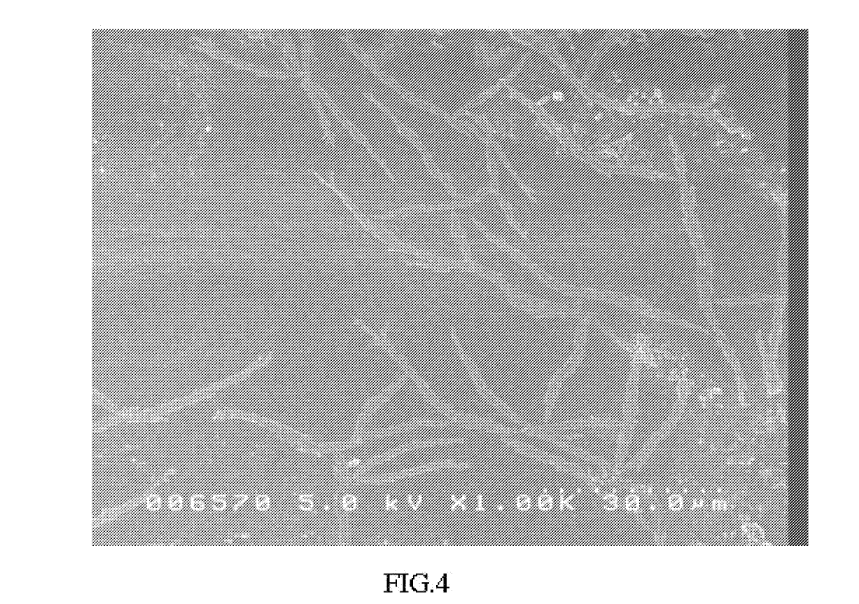

Refer to FIG. 3 and FIG. 4 the 1000× surface topographies of the composite solid polymer electrolyte membranes fabricated respectively via sulfonating the polyethylene/polypropylene non-woven cloth for 3 hours and 72 hours and soaking the sulfonated polyethylene/polypropylene non-woven cloth in the blended polymer solution with the blending ratio of PVA to PAA 10:5. As shown in the images revealed by the Hitachi scanning electron microscope, the sulfonation extent of the polyethylene/polypropylene non-woven cloth increases with the reaction time. The longer the reaction time, the better the combination between the sulfonic groups and the non-woven cloth. The higher the sulfonation extent, the better the combination between the polyethylene/polypropylene non-woven cloth and the blended polymer of PVA and PAA. Therefore, the sulfonation time and sulfonation process of the polyethylene/polypropylene non-woven cloth has much influence on the reaction between the polyethylene/polypropylene non-woven cloth and the blended polymer of PVA and PAA.

The polyethylene/polypropylene non-woven cloths sulfonated for 72 hours are used as samples for tests described below.

Table.1 shows the tensile strengths and elongations of the samples obtained with an Instron tensile test machine, and the samples include: the polyethylene/polypropylene non-woven cloth sulfonated for 72 hours (s-PP/PE (72 h)), the membrane of the blended polymer solution of PVA (polyvinyl alcohol) and PAA (polyacrylic acid) with the ratio of PVA to PAA 10:5 and without the polyethylene/polypropylene non-woven cloth (PVA:PAA (10:5)), and the composite solid polymer electrolyte membranes fabricated with the polyethylene/polypropylene non-woven cloths sulfonated for 72 hours and the blended polymer solutions of PVA and PAA with the ratios of PVA to PAA 10:3, 10:5 and 10:7.5 (s-PP/PE/PVA:PAA (10:3), s-PP/PE/PVA:PAA (10:5) and s-PP/PE/PVA:PAA (10:7.5)). It is observed from Table.1: the tensile strength of the polyethylene/polypropylene non-woven cloth sulfonated for 72 hours (s-PP/PE (72 h)) is 4.39 MPa; for the composite solid polymer electrolyte membranes fabricated with the polyethylene/polypropylene non-woven cloths sulfonated for 72 hours and the blended polymer solutions of PVA and PAA, the tensile strength increases to be 12.15 MPa when the ratio of PVA to PAA is 10:3 (s-PP/PE/PVA:PAA (10:3). Such a phenomenon implies that the polyethylene/polypropylene non-woven cloth having been sulfonated for 72 hours can combine well with the blended polymer solution of PVA and PAA, and that the composite solid polymer electrolyte membrane has the perfect shell-core structures in both the surface and the interior. When the ratio of PVA to PAA is increased to be 10:5 and 10:7.5, the tensile strengths of the composite solid polymer electrolyte membranes are respectively reduced to be 11.89 MPa and 7.23 MPa. PAA molecule has a lower strength; therefore, increasing the proportion of PAA decreases the mechanical strength of the composite solid polymer electrolyte membrane. However, the tensile strength of the composite solid polymer electrolyte membranes with a greater proportion of PAA is still higher than 2.45 MPa the tensile strength of the membrane of the blended polymer solution of PVA and PAA with the ratio of PVA to PAA 10:5 and without the polyethylene/polypropylene non-woven cloth (PVA:PAA (10:5)).

TABLE 1

| | Properties | | | |
|---|---|---|---|---|
| | Thickness | Width | Strength | Elongation |
| Samples | (mm) | (mm) | (MPa) | (%) |
| s-PP/PE(72 h) | 0.2 | 15 | 4.39 | 54 |
| PVA:PAA(10:5) | 0.45 | 10 | 2.45 | 93 |
| s-PP/PE/PVA:PAA(10:3) | 0.52 | 10 | 12.15 | 62 |
| s-PP/PE/PVA:PAA(10:5) | 0.55 | 10 | 11.89 | 58 |
| s-PP/PE/PVA:PAA(10:7.5) | 0.55 | 10 | 7.23 | 56 |

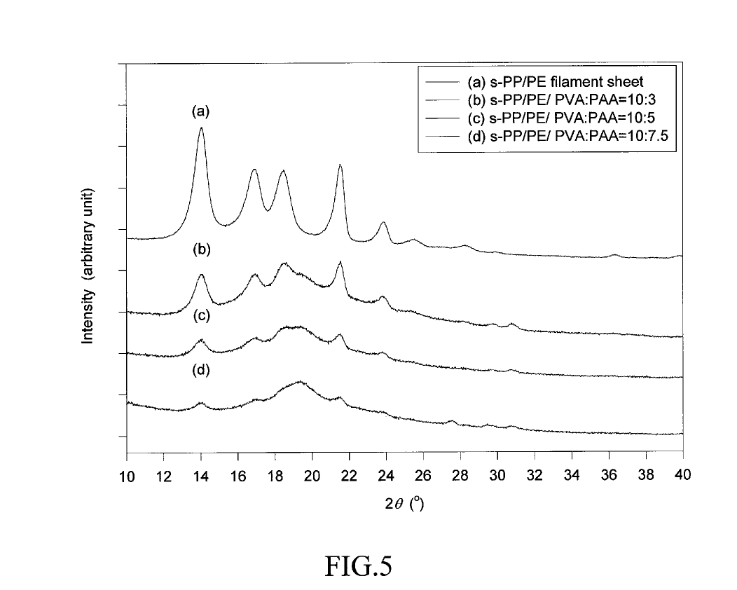

The crystallinities of samples are tested with a Philip X'Pert X-ray diffractometer. The samples include: the polyethylene/polypropylene non-woven cloth sulfonated for 72 hours (s-PP/PE (72 h)), and the composite solid polymer electrolyte membranes fabricated with the polyethylene/polypropylene non-woven cloths sulfonated for 72 hours and the blended polymer solutions of PVA and PAA with the ratios of PVA to PAA 10:3, 10:5 and 10:7.5 (s-PP/PE/PVA:PAA (10:3), s-PP/PE/PVA:PAA (10:5) and s-PP/PE/PVA:PAA (10:7.5)), wherein all of them are dried at a constant temperature of 40□ for 36 hours and respectively cut into pieces and stuck onto 6 cm×2 cm glass plates with adhesive tapes. The dried samples are scanned at normal temperature and pressure with the CuK_{α} radiation having the wavelength of 1.5406 Å within the range of 10°-80° of the 2θ angle and at the rate of 2°/min. The test results are shown in FIG. 5, wherein Curve (a) is the test result of the polyethylene/polypropylene non-woven cloth sulfonated for 72 hours (s-PP/PE (72 h)), and Curves (b)-(d) are respectively the test results of the composite solid polymer electrolyte membranes fabricated with the polyethylene/polypropylene non-woven cloths sulfonated for 72 hours and the blended polymer solutions of PVA and PAA with the ratios of PVA to PAA 10:3, 10:5 and 10:7.5 (s-PP/PE/PVA:PAA (10:3), s-PP/PE/PVA:PAA (10:5) and s-PP/PE/PVA:PAA (10:7.5)). It is observed in FIG. 5 that there are significant crystalline peaks at 14°, 17°, 18.5°, 21.5°, 23.5° and 25° in Curve (a). However, the heights of the crystalline peaks are obviously decreased in curves (b)-(d) of the composite solid polymer electrolyte membranes fabricated with the polymer solutions having different ratios of PVA to PAA; the higher the proportion of PAA, the lower the crystalline peaks. Such a phenomenon implies that the sulfonated polyethylene/polypropylene non-woven cloth is well combined with the blended polymer solution of PVA and PAA without any segregation, and that PVA and PAA can effectively wrap the fibers of the polyethylene/polypropylene non-woven cloth and can effectively reduce the crystallinity of the composite solid polymer electrolyte membrane. Such an effect greatly benefits the ionic conductivity of the polymer electrolyte, which is implemented by the amorphous regions.

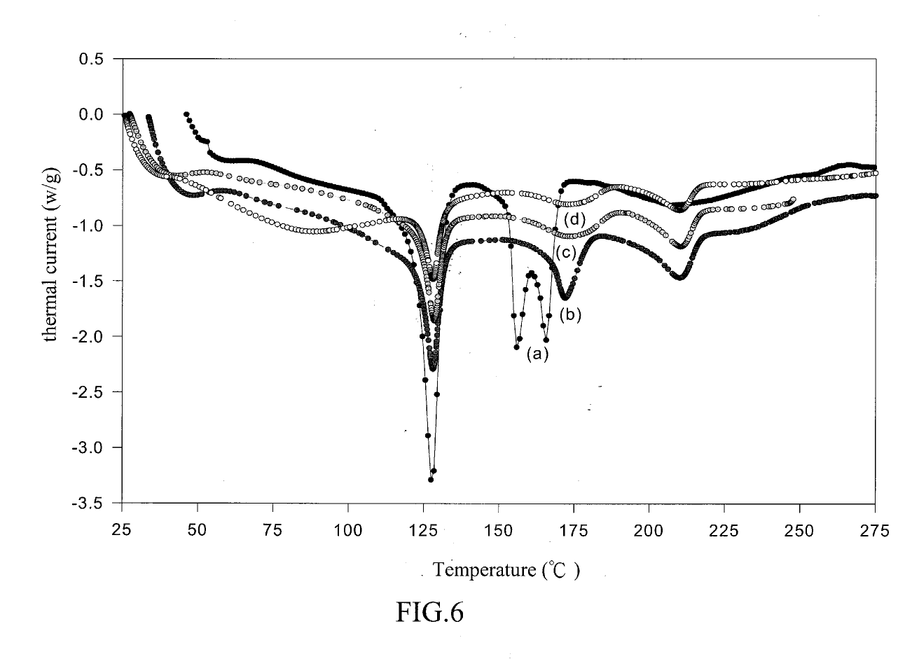

The thermal properties of samples are tested with a Perkin-Elmer DSC Pyrisl differential scanning calorimeter. The samples include: the polyethylene/polypropylene non-woven cloth sulfonated for 72 hours (s-PP/PE (72 h)), and the composite solid polymer electrolyte membranes fabricated with the polyethylene/polypropylene non-woven cloths sulfonated for 72 hours and the blended polymer solutions of PVA and PAA with the ratios of PVA to PAA 10:3, 10:5 and 10:7.5 (s-PP/PE/PVA:PAA (10:3), s-PP/PE/PVA:PAA (10:5) and s-PP/PE/PVA:PAA (10:7.5)), wherein all of them are dried at a constant temperature of 40□ for 36 hours and respectively cut into pieces of 5-10 mg and contained in airtight aluminum trays. The dried samples are heated at a rate of 10□/min from 25 to 300□. The test results are shown in FIG. 6, wherein Curve (a) is the test result of the polyethylene/polypropylene non-woven cloth sulfonated for 72 hours (s-PP/PE (72 h)), and Curves (b)-(d) are respectively the test results of the composite solid polymer electrolyte membranes fabricated with the polyethylene/polypropylene non-woven cloths sulfonated for 72 hours and the blended polymer solutions of PVA and PAA with the ratios of PVA to PAA 10:3, 10:5 and 10:7.5 (s-PP/PE/PVA:PAA (10:3), s-PP/PE/PVA:PAA (10:5)) and s-PP/PE/PVA:PAA (10:7.5)). It is observed in FIG. 6 that there are three heat-absorption peaks, i.e. the melting points Tₘ, at 130□, 160□ and 170□ in Curve (a), which proves that the polyethylene/polypropylene non-woven cloth is a crystalline structure. However, the heat-absorption peaks are obviously changed in curves (b)-(d) of the composite solid polymer electrolyte membranes containing the polymer solutions having different ratios of PVA to PAA. Besides, those two heat-absorption peaks at 160□ and 170□ are combined into a single heat-absorption peak, and a new heat-absorption peak appears at 220□, which is in fact the melting point of PVA. Further, those two heat-absorption peaks get closer with the increasing ratio of PVA to PAA, and their intensities decrease with the increasing ratio of PVA to PAA. Those test results of the differential scanning calorimeter imply that the sulfonated polyethylene/polypropylene non-woven cloth is well integrated with blended polymer solution of PVA and PAA. The reduction of the crystallinity shown in the test results will greatly benefit the ionic conductivity of the composite solid polymer electrolyte membrane fabricated according to the method of the present invention and is very useful in batteries.

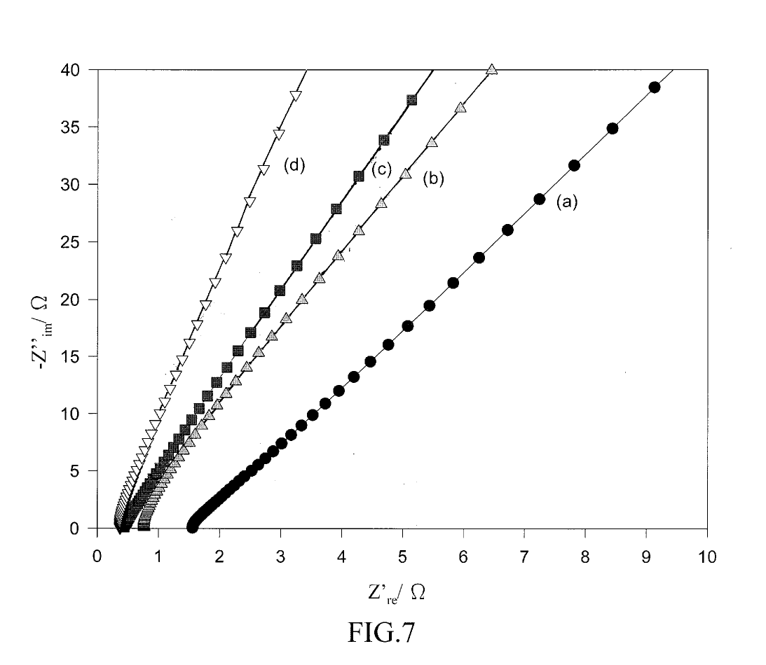

The thicknesses of samples are tested with a digital thickness gauge, and the resistances and ionic conductivities of the samples are tested with an AUTOLAB FRA electrochemical impedance analyzer (having bipolar type stainless steel electrodes) according to a sandwich rule. The samples include: the polyethylene/polypropylene non-woven cloth sulfonated for 72 hours (s-PP/PE (72 h)), and the composite solid polymer electrolyte membranes fabricated with the polyethylene/polypropylene non-woven cloths sulfonated for 72 hours and the blended polymer solutions of PVA and PAA with the ratios of PVA to PAA 10:3, 10:5 and 10:7.5 (s-PP/PE/PVA:PAA (10:3), s-PP/PE/PVA:PAA (10:5) and s-PP/PE/PVA:PAA (10:7.5)), wherein all of them are soaked in the basic aqueous solution with 32 wt. % of KOH for 72 hours at normal temperature and pressure and then swabbed to dry the surfaces and cut into the pieces one centimeter square. The AUTOLAB FRA electrochemical impedance analyzer tests the resistance with the scanning frequency of 1 to 100 Hz and the amplitude of 10 mV. The relationship between the conductivity and the impedance is expressed by the equation: [σ=l/(R_{b}×A)], wherein σ denotes the conductivity, l denotes the membrane thickness, R_{b} denotes the impedance, and A denotes the area. In the Nyquist diagram shown in FIG. 7, when the coordinates of the vertical −Z″ᵢₘ axis are 0, the curves intersect the horizontal Z′ᵣₑ axis, and the intercepts at the horizontal Z′ᵣₑ axis are the resistances of the polymer membranes (Z′ᵣₑ=R_{b}). The test results are arranged in Table.2. From Table.2 and FIG. 7, it is observed that the conductivities of the test samples increase from 0.0163 S/cm of s-PP/PE (72 h) to 0.21 S/cm of s-PP/PE/PVA:PAA (10:7.5), and that the ionic conductivity increases with the increasing ratio of PVA to PAA. It proves that the combination of the sulfonated polyethylene/polypropylene non-woven cloth and the blended polymer solution of PVA and PAA can reduce the crystallinity of the composite solid polymer electrolyte membrane. Thus, the composite solid polymer electrolyte membrane fabricated according to the method of the present invention has a very high ionic conductivity.

TABLE 2

| | Properties | | |
|---|---|---|---|
| | Thickness | Resistance | Conductivity |
| Samples | (cm) | (ohm) | (s/cm) |
| s-PP/PE(72 h) | 0.02 | 1.5600 | 0.0163 |
| s-PP/PE/PVA:PAA(10:3) | 0.055 | 0.7800 | 0.0898 |
| s-PP/PE/PVA:PAA(10:5) | 0.057 | 0.4400 | 0.1650 |
| s-PP/PE/PVA:PAA(10:7.5) | 0.061 | 0.3700 | 0.2100 |

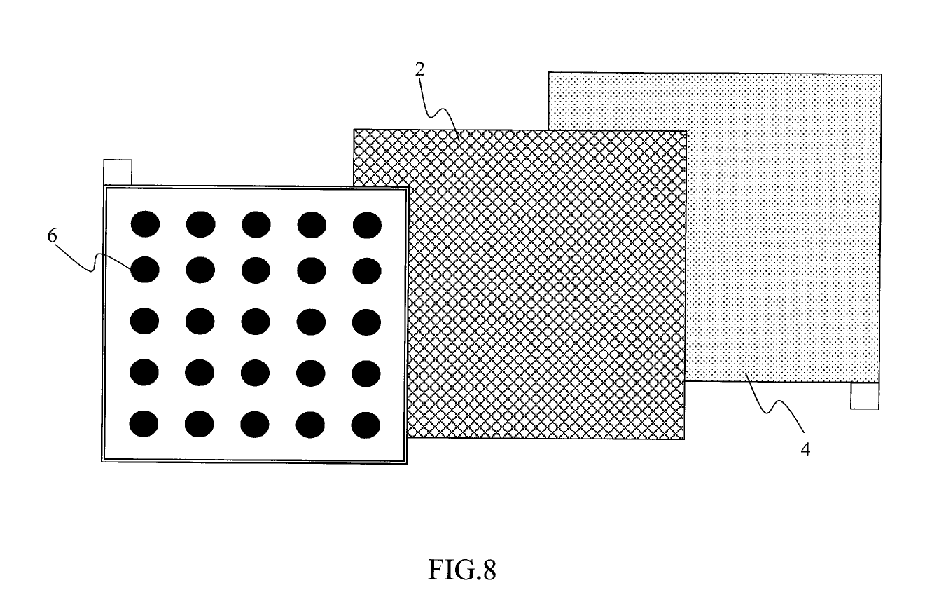

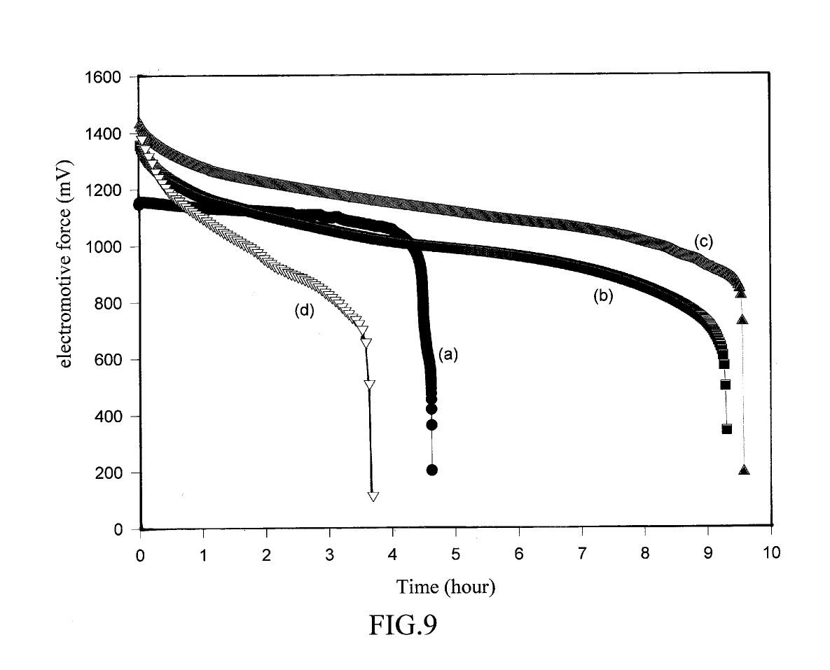

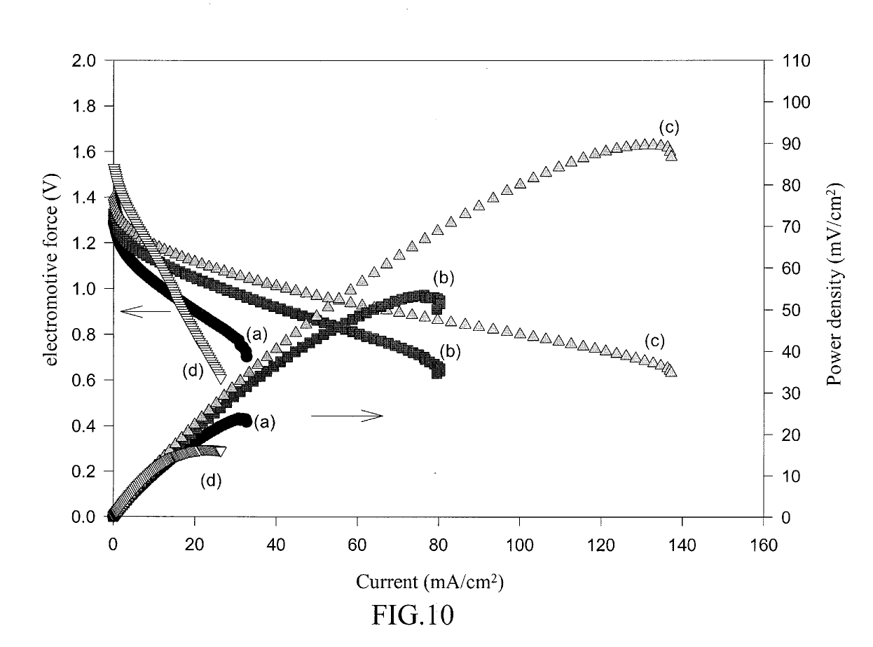

The membrane of the polyethylene/polypropylene non-woven cloth sulfonated for 72 hours (s-PP/PE (72 h)), and the composite solid polymer electrolyte membranes fabricated with the polyethylene/polypropylene non-woven cloths sulfonated for 72 hours and the blended polymer solutions of PVA and PAA with the ratios of PVA to PAA 10:3, 10:5 and 10:7.5 (s-PP/PE/PVA:PAA (10:3), s-PP/PE/PVA:PAA (10:5) and s-PP/PE/PVA:PAA (10:7.5)) are used in Zn-air batteries to observe their effects on the electric performances of the Zn-air batteries. Refer to FIG. 8 a diagram schematically showing a Zn-air battery, wherein a composite solid polymer electrolyte membrane 2 fabricated according to the present invention, a porous Zn electrode 4 and a carbon electrode functioning as the air electrode 6 are used to form the Zn-air battery. In the Zn-air battery, 3.2 gm of zinc gel having 60 wt. % of zinc powder is used as the negative electrode and has an electric capacity of 1574 mAh; the air electrode, which is made of carbon powder, is used as the positive electrode; one of the abovementioned test membranes (s-PP/PE (72 h), s-PP/PE/PVA:PAA (10:3), s-PP/PE/PVA:PAA (10:5) and s-PP/PE/PVA:PAA (10:7.5)) is used as the electrolyte membrane and disposed between the Zn electrode and the air electrode; and an acrylic container is used to accommodate the abovementioned elements to form a solid-state Zn-air battery 3 cm long and 2 cm wide with a theoretical electric capacity of 1574 mAh. In the test, the Zn-air batteries are discharged at the rate of C/10 at the temperature of 25□, wherein C is the allowable maximum charging rate of the Zn-air batteries. Table.3 shows the effects of the abovementioned membranes on the electric performances of the Zn-air batteries discharged at the rate of C/10. Refer to FIG. 9 a diagram showing the relationships between the time and the electromotive forces of the Zn-air batteries using the test membranes. FIG. 10 is a diagram showing the curves of the discharge powers of the Zn-air batteries using the test membranes and proves that the Zn-air battery using the composite solid polymer electrolyte membrane fabricated according to the method of the present invention can achieve a very high power density, which is more than 100 mW/cm².

TABLE 3

| | Samples | | | |
|---|---|---|---|---|
| | | s-PP/PE/ | s-PP/PE/ | s-PP/PE/ |
| | s-PP/PE | PVA:PAA | PVA:PAA | PVA:PAA |
| Test items | (72 h) | (10:3) | (10:5) | (10:7.5) |
| Theoretical electric | 1574 | 1574 | 1574 | 1574 |
| capacity | | | | |
| (mAh) | | | | |
| Discharge current | 150 | 150 | 150 | 150 |
| (mA) | | | | |
| Discharge time | 4.63 | 93.08 | 95.71 | 36.95 |
| (hr) | | | | |
| Practical electric | 728 | 1465 | 1506 | 581 |
| capacity | | | | |
| (mAh) | | | | |
| Utilization rate | 46.27 | 93.08 | 95.71 | 36.95 |
| (%) | | | | |

From those discussed above, it is known that the present invention can fabricate a high mechanical strength and high ionic conductivity composite solid polymer electrolyte membrane, which has the advantage of low cost and high base resistance and can overcome electrolyte leakage of batteries.

Those described above are the embodiments to exemplify the present invention to enable the persons skilled in the art to understand, make and use the present invention. However, it is not intended to limit the scope of the present invention. Any equivalent modification and variation according to the spirit of the present is to be also included within the scope of the claims stated below.

What is claimed is:

1. A method for fabricating a composite solid polymer electrolyte membrane, comprising the following steps:
a. flushing and drying a membrane, and performing a sulfonation reaction on said membrane with sulfuric acid to obtain a sulfonated membrane;
b. flushing and drying said sulfonated membrane;
c. providing a first polymer solution and a second polymer solution, and adding a basic aqueous solution into said second polymer solution to undertake a hydrolysis and neutralization reaction;
d. mixing said first polymer solution and the hydrolyzed and neutralized said second polymer solution to obtain a blended polymer solution;
e. placing said sulfonated membrane obtained in Step b in said blended polymer solution, and sequentially adding a cross-linking agent and an initiator into a mixture of said sulfonated membrane and said blended polymer solution to undertake a polymerization reaction and then obtain a blended polymer solution-containing sulfonated membrane; and
f. flatly placing said blended polymer solution-containing sulfonated membrane on a plate, and drying said blended polymer solution-containing sulfonated membrane to obtain a composite solid polymer electrolyte membrane.

2. The method according to claim 1, wherein said membrane is a polyethylene/polypropylene non-woven cloth, a polyethylene cloth or a polypropylene cloth.

3. The method according to claim 2, wherein said polyethylene/polypropylene non-woven cloth or said polyethylene cloth has a porosity of 20-80% and a thickness of 0.05-0.5 mm.

4. The method according to claim 2, wherein said polypropylene cloth has a porosity of 20-70% and a thickness of 0.02-0.5 mm.

5. The method according to claim 2, wherein material of said polyethylene/polypropylene non-woven cloth is selected from the group consisting of Nylon 6 fiber, Nylon 6,6 fiber, polyester fiber and polyester/nylon composite fiber.

6. The method according to claim 1, wherein a concentration of said sulfuric acid ranges from 0.5 to 18 N (normality).

7. The method according to claim 1, wherein time for said sulfonation reaction in Step a ranges from 1 to 200 hours.

8. The method according to claim 1, wherein an ultrasonic vibrator is used in said flushing in Step a and Step b.

9. The method according to claim 1, wherein in Step b, said sulfonated membrane is flushed until a pH value of water running away from said sulfonated membrane is within 6-7; then, said sulfonated membrane is dried at a temperature of 60 μl.

10. The method according to claim 1, wherein said first polymer solution is obtained via mixing 1-90 wt. % of a first polymer and 50-80 wt. % of water in an airtight environment at a temperature between 50□˜90□.

11. The method according to claim 10, wherein said first polymer is PVA (polyvinyl alcohol) or PEO (polyethylene oxide).

12. The method according to claim 11, wherein said PVA has an average molecular weight of 20000-200000 and a purity of 50-99%.

13. The method according to claim 11, wherein said PEO has an average molecular weight of 20000-200000 and a purity of 50-99%.

14. The method according to claim 1, wherein said second polymer solution comprises 1-90 wt. % of PAA (polyacrylic acid) monomer.

15. The method according to claim 14, wherein said PAA monomer has a molecular weight of 72.06 and a purity of more than 90%.

16. The method according to claim 14, wherein said PAA monomer is selected from the group consisting of methylacrylic acid, maleic acid and vinyl acetate.

17. The method according to claim 1, wherein said cross-linking agent is selected from the group consisting of TAA (triallyl amine), N,N-dimethyl acrylamide, epichlorohydrin, paraformaldehyde, and polyol.

18. The method according to claim 1, wherein said cross-linking agent has a purity of 80-99.99% and participates in said polymerization reaction in the liquid state by a proportion of 0.001-20 wt. %.

19. The method according to claim 1, wherein in Step c, said cross-linking agent also is added into the hydrolyzed and neutralized said second polymer solution beforehand.

20. The method according to claim 1, wherein said initiator is selected from the group consisting of APS (ammonium persulfate), KPS (potassium persulfate), sodium persulfate, other persulfates and hydrogen peroxide.

21. The method according to claim 20, wherein said APS (ammonium persulfate) has a purity of 90-99%.

22. The method according to claim 20, wherein each of said KPS (potassium persulfate), sodium persulfate, other persulfates and hydrogen peroxide has a purity of 80-99%.

23. The method according to claim 1, wherein said initiator participates in said polymerization reaction by a proportion of 0.001-20 wt. %.

24. The method according to claim 1, wherein said basic aqueous solution is the aqueous solution of KOH or NaOH.

25. The method according to claim 1, wherein said basic aqueous solution has a purity of 50-90% and participates in said hydrolysis and neutralization reaction by a proportion of 1-90 wt. %.

26. The method according to claim 1, wherein in Step c, the neutralization extent of the hydrolyzed and neutralized said second polymer solution ranges from 5 to 100%.

27. The method according to claim 1, wherein the material of said plate is PTFE (polytetrafluoroethylene).

28. The method according to claim 1, wherein in Step f, said drying is undertaken at a temperature between 40□˜80□ and a relative humidity of 30-50 RH %.

29. The method according to claim 1, wherein a nanometric powder is added into said composite solid polymer electrolyte membrane.

30. The method according to claim 1, wherein nanometric granules, submicron granules, or micron granules are added into said composite solid polymer electrolyte membrane, and said granules are selected from the group consisting of hydrophilic granules of silicon dioxide, titanium dioxide, zirconium dioxide and ceramic oxides.

31. The method according to claim 1, wherein said composite solid polymer electrolyte membrane absorbs basic aqueous solutions, acid aqueous solutions, neutral aqueous solutions and alcohol solutions.

32. The method according to claim 1, wherein said composite solid polymer electrolyte membrane is applied to an electrochemical system.

33. The method according to claim 32, wherein said electrochemical system is selected from the following systems: alkaline electrolysis systems, electroplating systems, Zn-air batteries, Ni—H batteries, Ni—Cd batteries, Ni—Zn batteries, Ag—Zn batteries, direct methyl alcohol fuel batteries, fuel batteries, metal-air batteries, primary alkaline (Zn/MnO₂) batteries, secondary alkaline (Zn/MnO₂) batteries, and electrochemical capacitors.

34. The method according to claim 1, wherein said initiator is illuminated with ultraviolet light to initiate said polymerization reaction.
